(19) United States
(12) Patent Application Publication
(10) Pub. No.: US 2025/0265027 A1
(43) Pub. Date: Aug. 21, 2025

(54) PRINTING APPARATUS, METHOD OF CONTROLLING THE SAME, AND STORAGE MEDIUM

(71) Applicant: CANON KABUSHIKI KAISHA, Tokyo (JP)

(72) Inventor: Tomoya Miyoshi, Kanagawa (JP)

(21) Appl. No.: 19/046,705

(22) Filed: Feb. 6, 2025

(30) Foreign Application Priority Data
Feb. 16, 2024 (JP) 2024-022203

(51) Int. Cl. G06F 3/12

(52) U.S. Cl. CPC G06F 3/1287; G06F 3/1203; G06F 3/1268

(57) ABSTRACT

A printing apparatus is operable to function as a local printer that receives a print job from a client terminal and performs printing and is operable to function as a cloud printer that receives a print job from a cloud server and performs printing. The printing apparatus sets whether a predetermined print function is enabled or disabled in a case that the printing apparatus functions as the local printer, adds an attribute for performing a presence notification of the printing apparatus to attribute information of the printing apparatus in a case that the predetermined print function is set to enabled, and notifies the attribute information of the printing apparatus to the cloud server.

### BACKGROUND OF THE INVENTION

### Field of the Invention

The present invention relates to a printing apparatus, a method of controlling the same, and a storage medium.

### Description of the Related Art

In a known print service, printing has been realized by a user directly transmitting a print job from a client terminal such as a PC to a printing apparatus that can use the print service. On the other hand, in recent years, a cloud print service using a cloud service provided on the Internet has been proposed.

When using the cloud print service, the user registers the printing apparatus in the cloud print service from the client terminal. At this time, the printing apparatus registers the printing apparatus together with printer attributes of the printing apparatus in the cloud print service. Then, when executing printing from the client terminal, the client terminal searches for a printing apparatus on the network, and obtains capability information of the printing apparatus from the found printing apparatus. Then, when it is determined based on the capability information that the printing apparatus is compatible with printing from the client terminal, the user of the client terminal transmits a print job to the relevant printing apparatus and causes the printing apparatus to perform printing.

Japanese Patent Laid-Open No. 2020-35233 describes that in a printing system including an information processing device operated by a user, a printing apparatus, and a server, in a case where a function usable in the printing apparatus is restricted, capability information of the printing apparatus is changed, and the changed capability information is notified to the information processing device.

In a case where the printing apparatus in the cloud print service described above is compatible with both local printing and cloud printing, a case where a client terminal compatible with the local printing performs printing using the printing apparatus by the cloud printing will be considered. It is known that when a client terminal compatible with the local printing attempts to perform printing using a printing apparatus by the cloud printing, although the printing apparatus is actually compatible with printing by the cloud printing, the client terminal cannot determine whether or not the printing apparatus is compatible with the cloud printing. Therefore, the found printing apparatus cannot be presented by the client terminal to the user as a printing apparatus of printing target.

In addition, in AirPrint (registered trademark), for example, IPP operation such as IdentifyPrinter is used as a function for allowing a user to know, when the printer to be used is selected by a mobile device of the user, where the selected printer is actually located. When the user operates the mobile device to select a printer and makes a request for an IdentifyPrinter or the like, the requested printer notifies the user of the position of the printer by an identification action operation such as making a sound or turning on a light. However, regarding such a function as well, since the function cannot be determined by the client terminal compatible with the local printing, such a function cannot be presented to the user.

### SUMMARY OF THE INVENTION

Embodiments of the present disclosure eliminate the above-mentioned issues with conventional technology.

A feature of embodiments of the present disclosure is to provide a technique that can present, to a user, an attribute obtained by making a predetermined print function in local printing enabled in a printing apparatus compatible with both local printing and cloud printing.

According to embodiments of the present disclosure, there is provided a printing apparatus comprising: one or more controllers including one or more processors and one or more memories, the one or more controllers configured to: be operable to cause the printing apparatus to function as a local printer that receives a print job from a client terminal and performs printing; be operable to cause the printing apparatus to function as a cloud printer that receives a print job from a cloud server and performs printing; set whether a predetermined print function is enabled or disabled in a case that the printing apparatus functions as the local printer; add an attribute for performing a presence notification of the printing apparatus to attribute information of the printing apparatus in a case that the predetermined print function is set to enabled; and notify the attribute information of the printing apparatus to the cloud server.

According to embodiments of the present disclosure, there is provided a method of controlling a printing apparatus, the method comprising: being operable to cause the printing apparatus to function as a local printer that receives a print job from a client terminal and performs printing; being operable to cause the printing apparatus to function as a cloud printer that receives a print job from a cloud server and performs printing; setting whether a predetermined print function is enabled or disabled in a case that the printing apparatus functions as the local printer; adding an attribute for performing a presence notification of the printing apparatus to attribute information of the printing apparatus in a case that the predetermined print function is set to enabled; and notifying the attribute information of the printing apparatus to the cloud server.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a sequence diagram for describing a flow of processing in cloud printing using a printing system according to an exemplary embodiment.

FIG. 2 is a diagram for explaining a processing sequence in local printing in which a print job is directly transmitted from a client terminal to a printing apparatus to cause printing.

FIG. 3 is a configuration diagram of a printing system that realizes cloud printing according to the embodiment.

FIG. 4 is a block diagram for explaining a hardware configuration of a printing apparatus according to the embodiment.

FIG. 5 is a functional block diagram for explaining a software configuration of the printing apparatus according to the embodiment.

FIG. 6 depicts a view illustrating an outer appearance of an operation panel of the printing apparatus according to the embodiment.

FIG. 7 is a diagram for explaining an example of printer attributes of the printing apparatus according to the embodiment.

FIG. 8 is a flowchart for explaining processing when an AirPrint-compatible client terminal searches for an AirPrint-compatible printing apparatus via a cloud.

FIG. 9 is a diagram for explaining a list of printing apparatuses and attributes indicating AirPrint-compatibility in the embodiment.

FIG. 10 depicts a view illustrating an example of a screen displaying a search result when an AirPrint-compatible client terminal searches for AirPrint-compatible printing apparatuses via a cloud.

FIG. 11 depicts a view illustrating an example of a UI setting menu screen of the printing apparatus according to a first embodiment.

FIG. 12 is a diagram for describing a timing at which the printing apparatus according to the first embodiment transmits printer attributes to a cloud print service.

FIG. 13 is a flowchart for explaining processing when the printing apparatus according to the first embodiment transmits printer attributes to the cloud print service.

FIG. 14 is a flowchart for explaining processing when the printing apparatus according to the first embodiment transmits printer attributes to the cloud print service when the AirPrint setting is changed in the printing apparatus.

FIG. 15 is a flowchart for explaining processing when the printing apparatus according to the first embodiment transmits printer attributes to the client terminal.

FIG. 16 depicts a view illustrating an example of an identification action setting menu screen of a printing apparatus according to a second embodiment.

FIG. 17 is a flowchart for explaining processing when the printing apparatus according to the second embodiment transmits printer attributes to the cloud print service.

FIG. 18 is a flowchart for explaining processing when the printing apparatus according to the second embodiment transmits printer attributes to the cloud print service when the AirPrint setting of the printing apparatus is changed.

FIG. 19 is a flowchart for explaining processing when the printing apparatus according to the second embodiment transmits printer attributes to the client terminal.

FIG. 20 depicts a view illustrating another example of the identification action setting menu screen of the printing apparatus according to the second embodiment.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

FIG. 3 is a configuration diagram of a printing system that realizes cloud printing according to an embodiment.

A printing apparatus 101 is connected to the Internet 302 via a LAN 301 and a firewall 303. A client terminal 100 is connected to the Internet 302 via the LAN 301 and a firewall 304.

A cloud print service 102 exists on the Internet 302, and can communicate with the printing apparatus 101 via the LAN 301 and the firewall 303. Furthermore, the cloud print service 102 can also communicate with the client terminal 100 via the LAN 301 and the firewall 304.

In addition, the printing apparatus 101 is connected to the client terminal 100 via the LAN 301, so that the printing apparatus 101 and the client terminal 100 can directly communicate with each other via the LAN 301. As described above, the printing apparatus 101 is compatible with both cloud printing and local printing. Note that in FIG. 3, the firewalls 303 and 304 may not be included in the network.

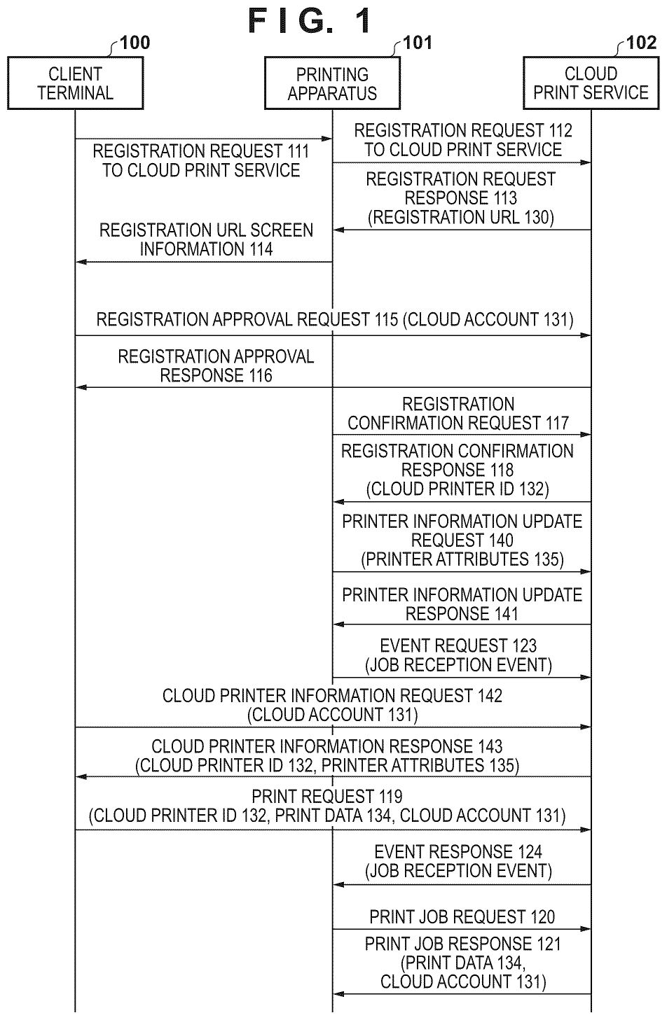

FIG. 1 is a sequence diagram for describing a flow of processing in cloud printing using a printing system according to the embodiment.

It is assumed that the printing apparatus 101 supports a cloud print function and a Web UI function for operating the printing apparatus 101. Furthermore, it is assumed that the client terminal 100 supports a cloud print client function and a Web UI client for operating the Web UI.

First, using the Web UI client of the client terminal 100, the user transmits a registration request 111 for registering the printing apparatus 101 in the cloud print service 102 to the printing apparatus 101 via the Web UI. Upon receiving the registration request 111, the printing apparatus 101 transmits a registration request 112 for registering the printing apparatus 101 in the cloud print service to the cloud print service 102. Upon receiving the registration request 112, the cloud print service 102 transmits a registration request response 113 including a registration URL 130 for cloud print registration to the printing apparatus 101. When receiving the registration request response 113, the printing apparatus 101 transmits registration URL screen information 114 including the registration URL 130 to the client terminal 100 via the Web UI.

When receiving the screen information 114, the client terminal 100 displays a registration URL 130 on the Web UI client. Next, the user operates the Web UI client of the client terminal 100 to access the displayed registration URL 130. As a result, the client terminal 100 transmits a registration approval request 115 including a cloud account 131 to the cloud print service 102. Upon receiving the registration approval request 115, the cloud print service 102 transmits a registration approval response 116 to the client terminal 100. Here, the cloud account 131 indicates a user having authority to use the cloud print service 102, and it is assumed that the user of the client terminal 100 has registered the user account in the cloud print service 102 in advance. Thus, the printing apparatus 101 is ready to be registered in the cloud print service 102.

Next, the printing apparatus 101 transmits a registration confirmation request 117 to the cloud print service 102. Upon receiving the registration confirmation request 117, the cloud print service 102 transmits a registration confirmation response 118 including a cloud printer ID 132 to the printing apparatus 101. At this stage, the printing apparatus 101 is registered in the cloud print service 102 for the first time, and the cloud print service 102 is in an available state.

When the registration to the cloud print service 102 is completed in this way, the printing apparatus 101 then transmits a printer information update request 140 to the cloud print service 102. The printer information update request 140 includes printer attributes 135 (attribute information) of the printing apparatus 101. Upon receiving the printer information update request 140, the cloud print service 102 transmits a printer information update response 141 to the printing apparatus 101. The capability information of the printing apparatus 101 is registered in the cloud print service 102 in this manner.

Next, the printing apparatus 101 transmits an event request 123 to the cloud print service 102. The event request 123 designates a job reception event as a type of event to be requested. Upon receiving the print job using the printing apparatus 101, the cloud print service 102 that has received the event request 123 notifies the printing apparatus 101 of the occurrence of the event.

Next, the client terminal 100 transmits a cloud printer information request 142 to the cloud print service 102. The cloud printer information request 142 includes the cloud account 131 of the user. Upon receiving the cloud printer information request 142, the cloud print service 102 obtains printer information that the cloud account 131 included therein can use. Then, a cloud printer information response (cloud printer information request) 143 including the cloud printer ID 132 indicating the printer information and the printer attributes 135 are transmitted to the client terminal 100. Here, the printer attributes 135 are transmitted to the cloud print service 102 by the printing apparatus 101 by the printer information update request 140.

Next, in order to start printing, the client terminal 100 transmits a print request 119 including the cloud printer ID 132, print data 134, and the cloud account 131 to the cloud print service 102. Upon receiving the print request 119, the cloud print service 102 transmits an event response 124 to the printing apparatus 101. The event response 124 is transmitted as a response to the event request 123, and a job reception event is designated as a type of event.

Upon receiving the event response 124, the printing apparatus 101 transmits a print job request 120 to the cloud print service 102. In response to the print job request 120, the cloud print service 102 transmits a print job response 121 including the print data 134 and the cloud account 131 to the printing apparatus 101. In this way, the printing apparatus 101 executes printing based on the print data 134 included in the received print job response 121.

The procedure of the processing in which the client terminal 100 registers the printing apparatus 101 in the cloud print service 102 and the client terminal 100 causes the printing apparatus 101 to execute printing using the cloud print service 102 has been described above.

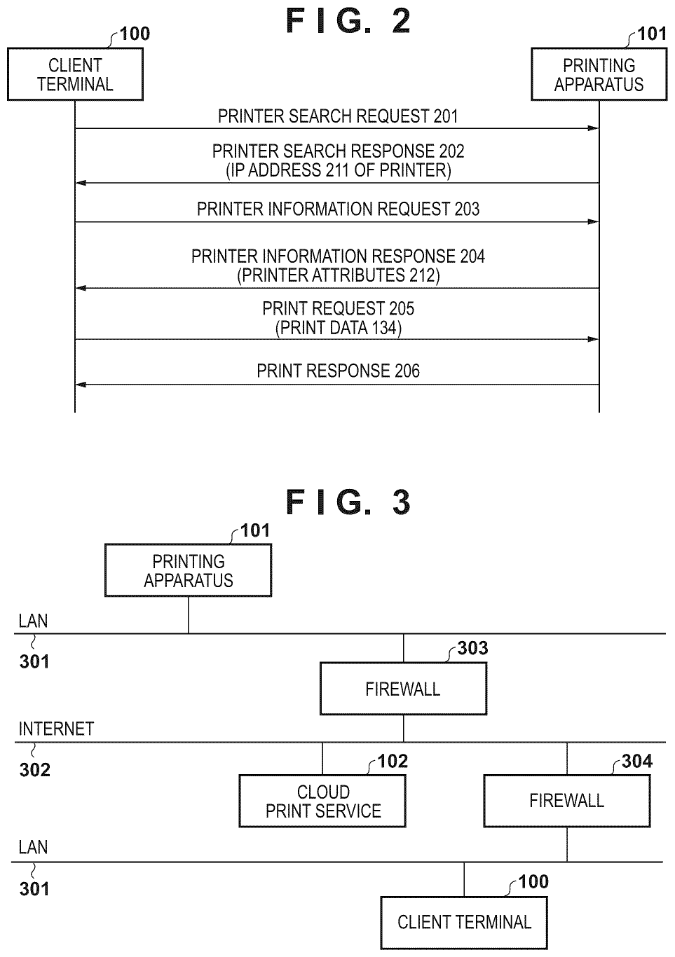

FIG. 2 is a diagram for explaining a processing sequence in local printing in which a print job is directly transmitted from the client terminal 100 to the printing apparatus 101 to cause the printing apparatus to perform printing in a case where the client terminal 100 and the printing apparatus 101 are connected to the LAN 301.

The client terminal 100 transmits a printer search request 201 to search for printers on the network (LAN 301). Upon receiving the printer search request 201, the printing apparatus 101 transmits a printer search response 202 to the client terminal 100. The client terminal 100 finds the printing apparatus 101 by receiving the printer search response 202.

Next, the client terminal 100 transmits a printer information request 203 to the found printing apparatus 101. When receiving the printer information request 203, the printing apparatus 101 transmits a printer information response 204 to the client terminal 100. The printer information response 204 includes printer attributes 212. As a result, the client terminal 100 can obtain the capability information of the printing apparatus 101. The capability information also includes information indicating whether or not the printing apparatus is compatible with printing from the 101 client terminal 100.

Then, when determining, from the received information, that the printing apparatus 101 is compatible with printing from the client terminal 100, the client terminal 100 performs control such as displaying the printing apparatus 101 in the printer selection list. In this way, the user of the client terminal 100 can perform an operation of transmitting a print job to the printing apparatus 101.

Then, when the user performs an operation of transmitting a print job to the printing apparatus 101, the client terminal 100 transmits a print request 205 to the printing apparatus 101. The print request 205 also includes print data 134. When receiving the print request 205, the printing apparatus 101 transmits a print response 206 to the client terminal 100. Then, the printing apparatus 101 prints the print data received in the print request 205.

As described above, the printing apparatus 101 can directly receive the print data from the client terminal 100 and print the print data by the local printing.

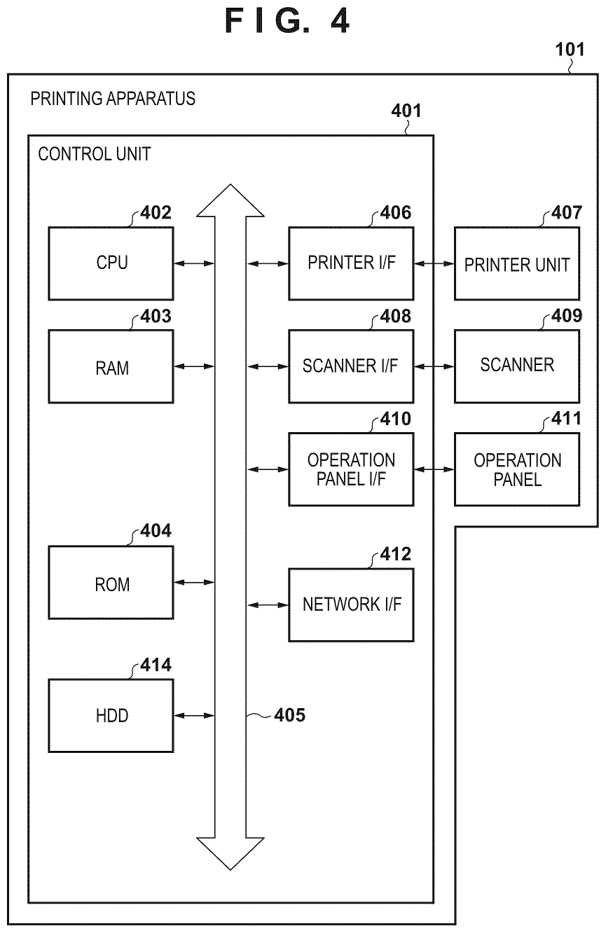

FIG. 4 is a block diagram for explaining a hardware configuration of the printing apparatus 101 according to the embodiment of the present invention. A control unit 401 including a CPU 402 controls the operation of the entire printing apparatus 101. The CPU 402 deploys a control program stored in a ROM 404 in a RAM 403, and performs various controls such as printing and communication control. The RAM 403 is used as a temporary storage area such as a main memory and a work area of the CPU 402. A hard disk drive (HDD) 414 stores data, various programs, various information tables, and the like. A printer I/F 406 serves as an interface for outputting an image signal to be printed in a printer unit (printer engine) 407. Furthermore, a scanner I/F 408 serves as an interface for inputting an image signal from a scanner (scanner engine) 409. The CPU 402 processes an image signal input from the scanner I/F 408, and outputs it to the printer I/F 406 as an image signal to be printed. An operation panel I/F 410 connects an operation panel 411 and the control unit 401. The operation panel 411 includes a display unit having a touch panel function, a keyboard, and the like. A network I/F 412 transmits information to an external device such as the client terminal 100 or the cloud print service 102, or receives various types of information from the external device. Each unit in the control unit 401 described above is connected via a system bus 405.

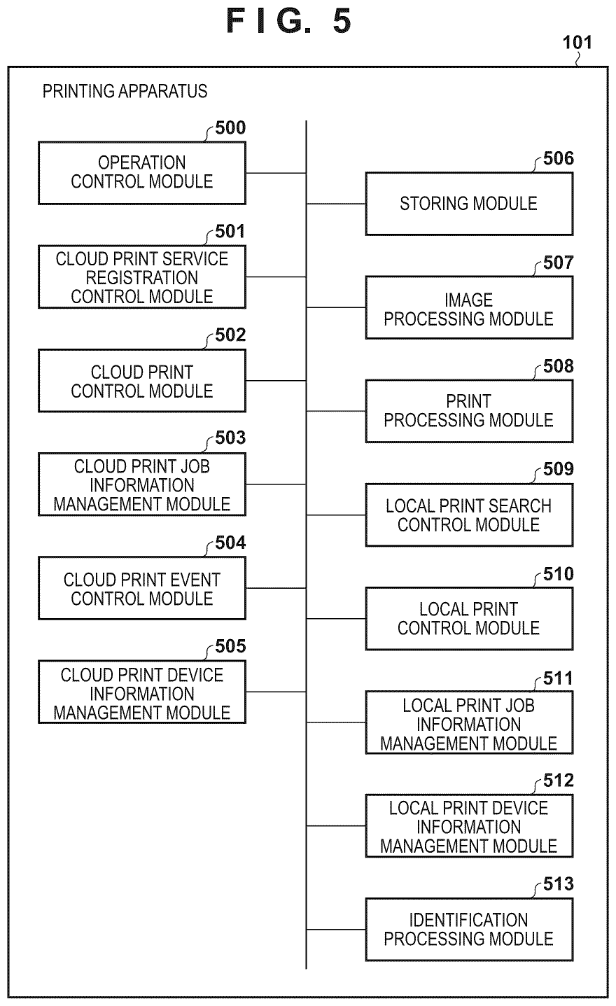

FIG. 5 is a functional block diagram for explaining a software configuration of the printing apparatus 101 according to the embodiment. Each functional module illustrated in FIG. 5 is realized by the CPU 402 of the printing apparatus 101 deploying the control program stored in the ROM 404 described above in the RAM 403 and executing the control program.

An operation control module 500 controls the operation panel 411. The operation control module 500 displays an operation menu on the operation panel 411 to wait for an instruction input from the user, notifies another functional module of received instruction content, and displays the result thereof on the operation panel 411. A cloud print service registration control module 501 analyzes the registration request 111 to the cloud print service 102 received from the client terminal 100, and transmits the registration request 112 to the cloud print service 102. In this way, registration processing of registering the printing apparatus 101 in the cloud print service 102 is controlled.

A cloud print control module 502 transfers the print data 134 received from the cloud print service 102 to an image processing module 507. The image processing module 507 performs processing of rendering a print job into image data for printing. A print processing module 508 controls the printer unit 407 based on the image data rendered by the image processing module 507 to perform print processing.

A cloud print job information management module 503 manages job information of the printing apparatus 101 and notifies the cloud print service 102. A cloud print event control module 504 controls processing of transmitting and receiving an event between the printing apparatus 101 and the cloud print service 102. A cloud print device information management module 505 manages device information of the printing apparatus 101 and notifies the cloud print service 102.

A storing module 506 stores designated data in the RAM 403, the HDD 405, or the like according to an instruction from another functional module, and reads data stored in the ROM 404, the RAM 403, the HDD 405, or the like. Examples of the data managed by the storing module 506 include ID information for specifying a device and two-dimensional barcode image information.

Upon receiving the printer search request 201 from the client terminal 100, a local print search control module 509 controls processing of transmitting the printer search response 202. A local print control module 510 transfers the print data 134 transmitted from the client terminal 100 in the print request 205 to the image processing module 507. A local print job information management module 511 manages job information received by the printing apparatus 101 in local printing, and notifies the client terminal 100. A local print device information management module 512 manages device information of the printing apparatus 101 and notifies the client terminal 100. In order to notify the presence of the printing apparatus 101, an identification processing module 513 performs processing such as, for example, making a sound or turning on a light.

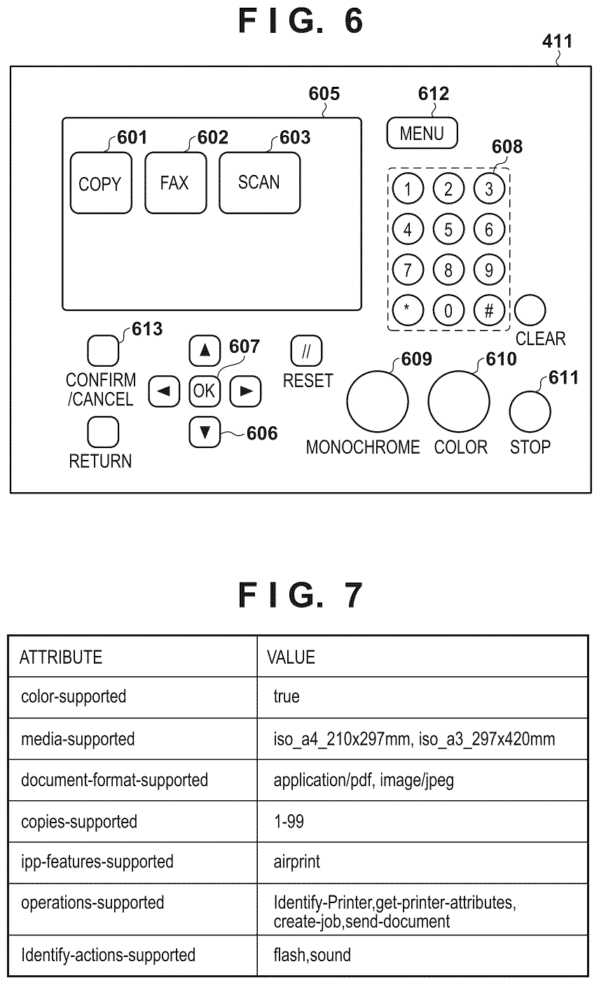

FIG. 6 depicts a view illustrating an outer appearance of the operation panel 411 of the printing apparatus 101 according to the embodiment.

A display panel 605 is, for example, a display panel using a liquid crystal display unit or the like. A copy button 601 is a button pressed when performing copying using the printing apparatus 101, and a copy screen is displayed on the display panel 605 when this button 601 is pressed. A FAX button 602 is a button pressed when performing facsimile communication using the printing apparatus 101, and a FAX screen is displayed on the display panel 605 when this button 602 is pressed. A scan button 603 is a button pressed when performing scanning using the printing apparatus 101, and a scan operation screen is displayed on the display panel 605 when this button 603 is pressed. A two-dimensional barcode image or the like is also displayed on the display panel 605.

A numeric keypad 608 is used to input numbers and the like. An OK key 607 is used to decide the display content of the display panel 605, or the like. Up, down, left, and right direction keys 606 are used to select a menu or the like displayed on the display panel 605. A monochrome copy button 609 and a color copy button 610 are used when executing monochrome copy and color copy, respectively. A stop key 611 is used when stopping the processing. A menu key 612 is used to display a menu screen for setting the printing apparatus 101. A button 613 is pressed to check the status of the printing apparatus 101, such as a list of print jobs being received by the printing apparatus 101.

FIG. 7 is a diagram for explaining an example of printer attributes of the printing apparatus 101 according to the embodiment.

The attribute of color-supported is an attribute indicating whether or not the printing apparatus 101 can perform color printing. When this attribute value is “true”, it indicates that color printing is possible, and when this attribute value is “false”, it indicates that color printing is impossible. In the example, “true” is set to indicate that color printing is possible.

The attribute of media-supported is an attribute indicating paper size information supported by the printing apparatus 101. The example indicates that A4 paper represented by “iso_a4_210×297 mm” and A3 paper represented by “iso_a3_297×420 mm” are supported.

The attribute of document-format-supported is an attribute indicating document format information supported by the printing apparatus 101. The example indicates that a PDF document format represented by “application/pdf” and a JPEG document format represented by “image/jpeg” are supported.

The attribute of copies-supported is an attribute indicating the number of copies supported by the printing apparatus 101. The example indicates that the number of copies from the number of copies 1 to the number of copies 99 represented by 1 to 99 is supported.

The attribute of ipp-features-supported indicates whether or not the printing apparatus 101 supports AirPrint, which is a predetermined print function that is one of the functions in local printing. The example indicates that AirPrint represented by “airprint” is supported.

The attribute of operations-supported is an attribute indicating the operation of the IPP supported by the printing apparatus 101. In FIG. 7, since AirPrint is supported, Identify-Printer operation is included as the attribute value.

The attribute of Identify-actions-supported indicates an identification action operation when the printing apparatus 101 makes a request for the IdentifyPrinter. “Sound” indicates a ringing sound, and “flash” indicates turning on a light (lighted display).

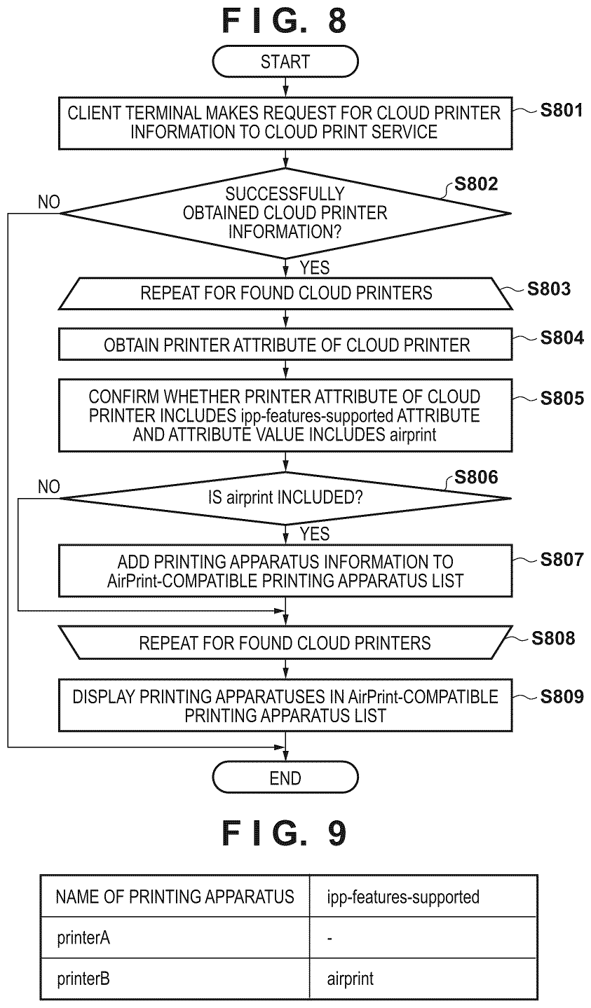

FIG. 8 is a flowchart for explaining processing when an AirPrint-compatible client terminal 100 searches for AirPrint-compatible printing apparatuses via a cloud. In FIG. 1, this corresponds to processing in which the client terminal 100 sends the cloud printer information request 142 to the cloud print service 102 and receives the cloud printer information response 143 from the cloud print service 102.

In step S801, the client terminal 100 transmits the cloud printer information request 142 to the cloud print service 102. In a case where the client terminal 100 receives the cloud printer information response 143 and determines that the cloud printer information has been obtained in step S802, the processing proceeds step S803, and in a case where it determines that the cloud printer information has not been obtained, the processing ends.

In step S803 to step S808, the client terminal 100 repeats the processing in step S804 to step S807 for the number of found cloud printers. First, in step S804, the client terminal 100 obtains the printer attributes 135 of the cloud printer included in the cloud printer information response 143 received from the cloud print service 102. Next, the processing proceeds to step S805, and the client terminal 100 confirms whether the obtained printer attributes 135 include the attribute of ipp-features-supported and the attribute value includes “airprint”. Then, in step S806, the processing proceeds to step S807 in a case that the attribute value includes “airprint” based on the confirmation result in step S805. On the other hand, in a case that there is no ipp-features-supported attribute or airprint is not included, the processing proceeds to step S808. In step S807, the client terminal 100 adds the found printing apparatus as a cloud printer to the AirPrint-compatible printing apparatus list. Then, the processing proceeds to step S808, and the processing from step S803 is repeated for the found cloud printers.

When the processing for the number of found cloud printers is ended, the processing proceeds to step S809, and the client terminal 100 displays the printing apparatuses included in the AirPrint-compatible printing apparatus list on the operation unit (not illustrated) of the client terminal 100 and presents the printing apparatuses to the user.

FIG. 9 is a diagram for explaining a list of printing apparatuses and attributes indicating AirPrint-compatibility in the embodiment.

In the embodiment, it is assumed that two printing apparatuses, whose printing apparatus names are printer A and printer B, are found. Here, it is assumed that printer A does not respond to ipp-features-supported, and printer B responds by setting the attribute “airprint” to the attribute ipp-features-supported.

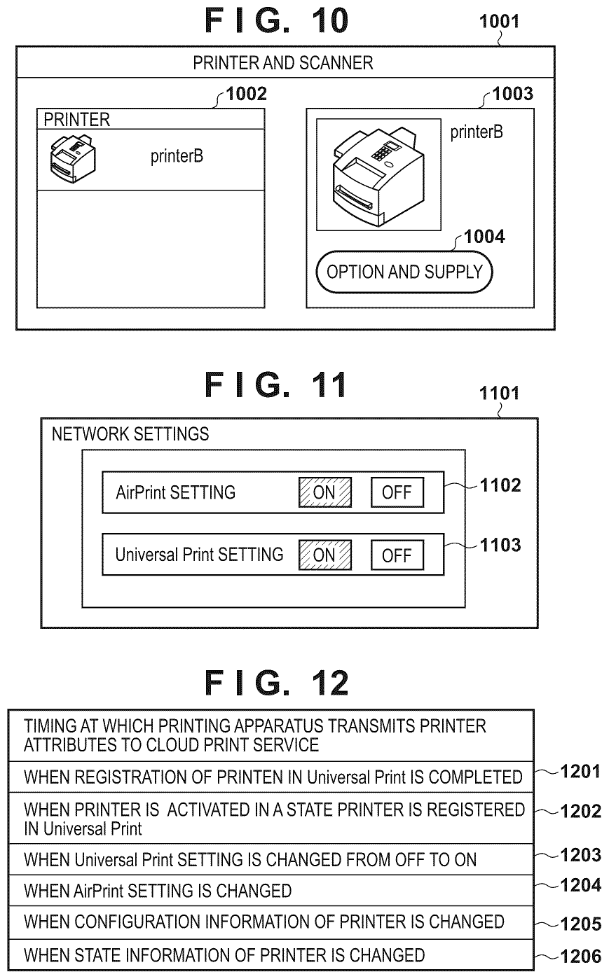

FIG. 10 depicts a view illustrating an example of a screen displaying a search result when an AirPrint-compatible client terminal 100 searches for an AirPrint-compatible printing apparatus via a cloud.

A screen 1001 is a screen showing a result of the search for AirPrint-compatible printing apparatuses in the AirPrint-compatible client terminal 100. An area 1002 displays printing apparatuses found by the search. The example shows that printer B has been found as an AirPrint-compatible printing apparatus. As explained in FIG. 9, printer B responds by setting the attribute “airprint” to the printer attribute ipp-features-supported. Therefore, this printer B has been found as an AirPrint-compatible printing apparatus in the AirPrint-compatible client terminal 100.

The user can select the printing apparatus displayed in the area 1002. The detailed information of the printing apparatus selected here is displayed in an area 1003. In the example, since printer B is selected in the area 1002, the detailed information of printer B is displayed in the area 1003. Specifically, an image icon of printer B and an “option and supply” button 1004 for transitioning to a screen for confirming option and supply information of printer B are displayed.

Examples of the present disclosure based on the above premise will be described with reference to a first embodiment and a second embodiment. First, the first embodiment will be described.

### First Exemplary Embodiment

FIG. 11 depicts a view illustrating an example of a UI setting menu screen of the printing apparatus 101 according to the first embodiment.

A network setting menu shown on a menu screen 1101 is displayed on the operation panel 411 of the printing apparatus 101. AirPrint setting 1102 can set AirPrint, which is a type of local printing to be enabled or disabled. When this setting 1102 is turned ON, the printing apparatus 101 operates as an AirPrint-compatible printing apparatus. UniversalPrint setting 1103 can set UniversalPrint, which is a type of cloud printing to be enabled or disabled. When this setting 1103 is turned ON, the printing apparatus 101 operates as a UniversalPrint-compatible printing apparatus. In FIG. 11, AirPrint is set to be enabled and Universal Print is set to be enabled. Therefore, in this case, the printing apparatus 101 is a printing apparatus that is compatible with both local printing and cloud printing. Note that the contents set in the UI setting menu screen 1101 are stored in the HDD 414 and referred to in the processing to be described later.

FIG. 12 is a diagram for describing a timing at which the printing apparatus 101 according to the first embodiment transmits printer attributes to the cloud print service 102.

There are the following six timings as the timing at which the printing apparatus 101 transmits the printer attributes to the cloud print service 102.

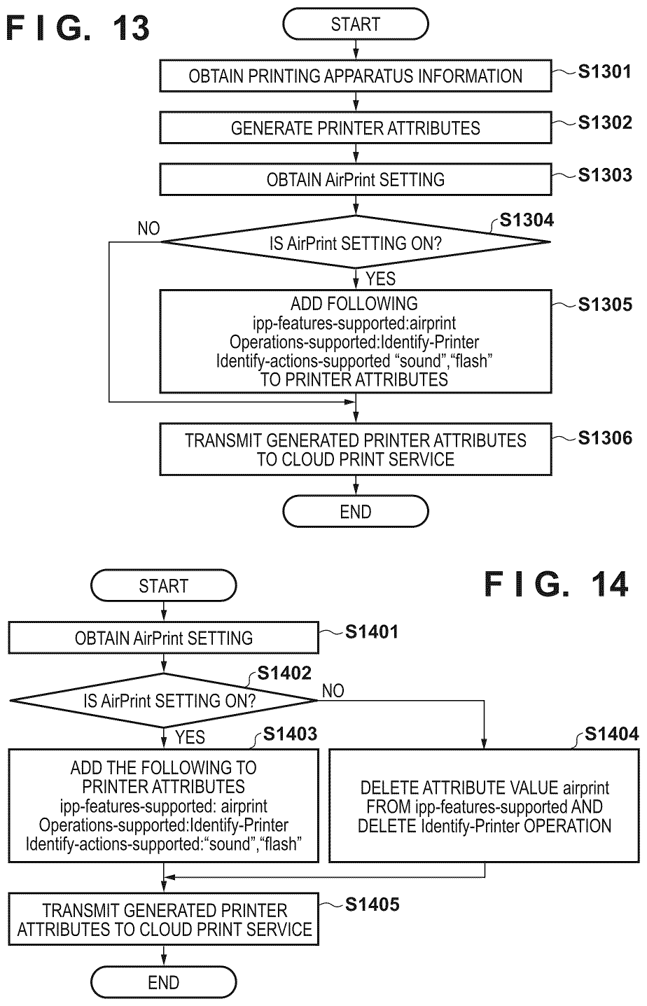

A first timing 1201 is when registration of the printing apparatus 101 in the Universal Print is completed. This is the timing of the printer information update request 140 in the processing sequence of cloud printing described in FIG. 1. The processing of the printing apparatus 101 at this time will be described later with reference to the flowchart of FIG. 13.

A second timing 1202 is when the printing apparatus 101 is activated in a state where the printing apparatus 101 is registered in the Universal Print. The processing of the printing apparatus 101 at this time will be described later with reference to the flowchart of FIG. 13.

A third timing 1203 is when the Universal Print setting is changed from OFF to ON. The processing of the printing apparatus 101 at this time will be described later with reference to the flowchart of FIG. 13.

A fourth timing 1204 is when the AirPrint setting is changed in a state where the printing apparatus 101 is registered in the Universal Print. The processing of the printing apparatus 101 at this time will be described later with reference to the flowchart of FIG. 14.

A fifth timing 1205 is when the configuration information of the printing apparatus 101 is changed. For example, the paper size set in the printing apparatus 101 is changed from A3 to A4.

A sixth timing 1206 is when the state information of the printing apparatus 101 is changed. For example, a no-paper error occurs in the printing apparatus 101.

FIG. 13 is a flowchart for explaining processing when the printing apparatus 101 according to the first embodiment transmits the printer attributes 135 to the cloud print service 102. This is processing when the printing apparatus 101 transmits the printer information update request 140 to the could print service 102 in the processing sequence of cloud printing in FIG. 1. Note that the processing described in the flowchart of FIG. 13 is realized by the CPU 402 of the printing apparatus 101 executing a program deployed in the RAM 403 and functioning as the functional module illustrated in FIG. 5.

First, in step S1301, the CPU 402 obtains printing apparatus information by functioning as the cloud print device information management module 505. This printing apparatus information is obtained from the printer unit 407 via the printer I/F 406. Next, the processing proceeds to step S1302, where the CPU 402 functions as the cloud print device information management module 505, and generates the printer attributes 135 from the printing apparatus information obtained in step S1301. The printer attributes 135 are encoded in a data format defined by the Internet Printing Protocol (IPP) or the like for transmission to the cloud print service 102. Next, the processing proceeds to step S1303, where the CPU 402 functions as the storing module 506 and obtains the AirPrint setting 1102 stored in the HDD 414. Then, the processing proceeds to step S1304, where the CPU 402 functions as the cloud print device information management module 505, and determines whether or not AirPrint is enabled in the AirPrint setting 1102 obtained in step S1303. Here, the processing proceeds to step S1305 in a case that it is determined that AirPrint is enabled, and the processing proceeds to step S1306 in a case that it is determined that AirPrint is disabled.

In step S1305, the CPU 402 functions as the cloud print device information management module 505, and sets the attribute value “airprint” to the attribute of ipp-features-supported in the printer attributes 135. Furthermore, the attribute value “Identify-Printer” is set to the attribute operations-supported. Furthermore, the attribute value “sound, flash” is set to the attribute of Identify-actions-supported. Then, the processing proceeds to step S1306, where the CPU 402 functions as the cloud print device information management module 505 and transmits the generated printer attributes 135 to the cloud print service 102.

According to this processing, when the AirPrint setting 1102 is set to ON in the network setting screen of FIG. 11, the printing apparatus 101 can set printer attributes corresponding thereto and notify the cloud print service 102 of the printer attributes.

FIG. 14 is a flowchart for explaining processing when the printing apparatus 101 transmits the printer attributes to the cloud print service 102 when the AirPrint setting is changed in the printing apparatus 101 according to the first embodiment. Note that the processing described in the flowchart of FIG. 14 is realized by the CPU 402 of the printing apparatus 101 executing a program deployed in the RAM 403 and functioning as the functional module illustrated in FIG. 5.

In step S1401, the CPU 402 functions as the storing module 506, and obtains the AirPrint setting 1102 stored in the HDD 414. Next, the processing proceeds to step S1402, where the CPU 402 functions as the cloud print device information management module 505, and determines whether AirPrint is enabled in the AirPrint setting 1102 obtained in step S1401. Here, in a case that it is determined that AirPrint is enabled, that is, changed from disabled to enabled, the processing proceeds to step S1403, and in a case that it is determined that AirPrint is disabled, that is, changed from enabled to disabled, the processing proceeds to step S1404.

In step S1403, the CPU 402 functions as the cloud print device information management module 505, and sets the attribute of ipp-features-supported and the attribute value “airprint” in the printer attributes 135. Furthermore, the attribute value “Identify-Printer” is set to the attribute operations-supported. Furthermore, the attribute value “sound, flash” is added to the attribute Identify-actions-supported, and the processing proceeds to step S1405.

On the other hand, in step S1404, the CPU 402 functions as the cloud print device information management module 505, and deletes the attribute value “airprint” from the attribute ipp-features-supported of the printer attributes 135. Furthermore. “Identify-Printer” operation is deleted from the attribute operations-supported, and the processing proceeds to step S1405. In step S1405, the CPU 402 functions as the cloud print device information management module 505, transmits the generated printer attributes 135 to the cloud print service 102, and ends this processing.

According to this processing, when the AirPrint setting is changed in a state where the printing apparatus 101 is registered in Universal Print, the printing apparatus 101 can notify the cloud print service 102 of the printer attributes corresponding to the change.

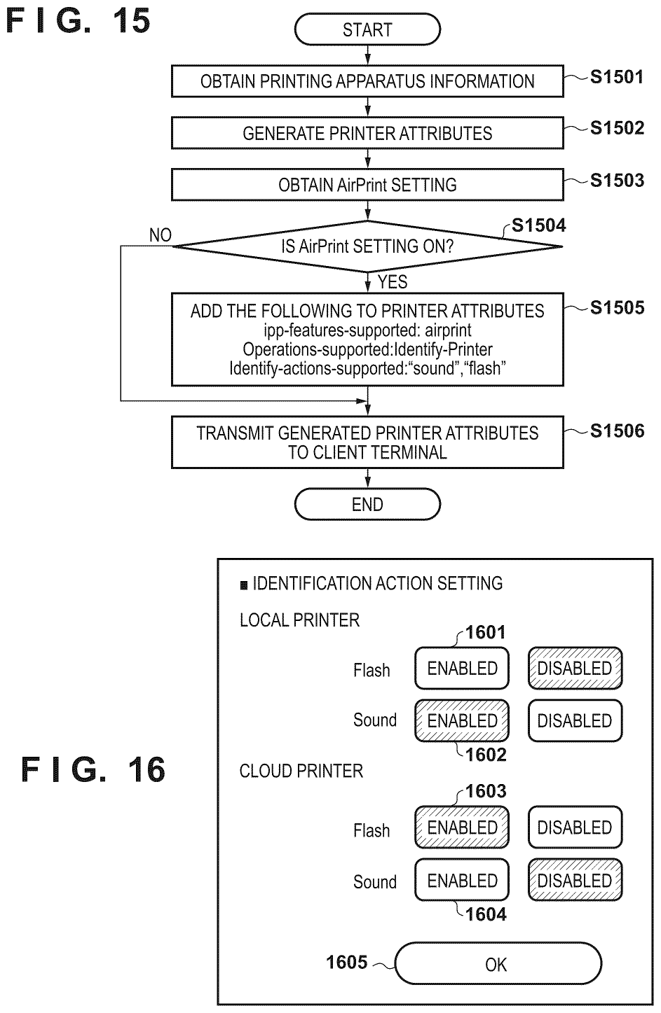

FIG. 15 is a flowchart for describing processing when the printing apparatus 101 according to the first embodiment transmits the printer attributes 212 to the client terminal 100. This is processing when the printing apparatus 101 transmits the printer information response 204 in the processing sequence diagram of local printing in FIG. 2. Note that the processing described in the flowchart of FIG. 15 is realized by the CPU 402 of the printing apparatus 101 executing a program deployed in the RAM 403 and functioning as the functional module illustrated in FIG. 5.

In step S1501, the CPU 402 functions as the local print device information management module 512, and obtains the printing apparatus information. This printing apparatus information is obtained from the printer unit 407 via the printer I/F 406. Next, the processing proceeds to step S1502, where the CPU 402 functions as the local print device information management module 512, and generates the printer attributes 212 from the obtained printing apparatus information. The printer attributes 212 are encoded in a data format defined by IPP or the like for transmission to the client terminal 100. Next, the processing proceeds to step S1503, where the CPU 402 functions as the storing module 506 and obtains the AirPrint setting 1102 stored in the HDD 414.

In step S1504, the CPU 402 functions as the local print device information management module 512, and determines whether or not AirPrint is enabled in the AirPrint setting 1102 obtained in step S1503. Here, in a case that it is determined that AirPrint is enabled, the processing proceeds to step S1505, and in a case that it is determined that AirPrint is disabled, the processing proceeds to step S1506. In step S1505, the CPU 402 functions as the local print device information management module 512, and sets the attribute value “airprint” to the attribute ipp-features-supported in the printer attributes 212. Furthermore, the attribute value “Identify-Printer” is set to the attribute operations-supported. Furthermore, the attribute value “sound, flash” is set to the attribute Identify-actions-supported, and the processing proceeds to step S1506. In step S1506, the CPU 402 functions as the local print device information management module 512, and transmits the generated printer attributes 212 to the client terminal 100.

According to this processing, in a case where AirPrint is set in the printing apparatus information, the printing apparatus 101 is able to transmit the printer attributes 212 corresponding thereto to the client terminal 100.

As described above, according to the first embodiment, in a case that a printing apparatus compatible with local printing and cloud printing supports AirPrint, a request for printer information from the AirPrint-compatible client terminal can be responded. Specifically, in either the local printing or the cloud printing, it is possible to notify the user of the identification action operation of the printing apparatus by “Identify-Printer” operation from the client terminal.

### Second Exemplary Embodiment

Next, a second embodiment will be described below. The Identify-Printer operation in the first embodiment is the same notification method for both the local print device and the cloud print device, and thus cannot be distinguished. Therefore, in the second embodiment, an example in which the local printing and the cloud printing can be distinguished by changing the notification method will be described. Specific examples will be described below. Note that the configuration of the printing system according to the second embodiment, the hardware configuration of the printing apparatus 101, and the like are similar to those of the first embodiment described above, and thus the description thereof will be omitted.

FIG. 16 depicts a view illustrating an example of an identification action setting menu screen of the printing apparatus 101 according to the second embodiment of the present invention. This screen is displayed on the operation panel 411.

On this identification action setting screen, it is possible to perform setting on each commanded identification action for the printing apparatus 101, and it is possible to set whether a flash setting 1601 for “flash” is enabled/disabled and whether a sound setting 1602 for “sound” is enabled/disabled when functioning as the local printer. Similarly, validity/invalidity of a flash setting 1603 for “flash” and a sound setting 1604 for “sound” when functioning as a cloud printer can also be set, and all settings on this screen are confirmed by an OK button 1605. The settings on the menu screen are stored in the HDD 414 and referred to in processing to be described later.

In FIG. 16, in the local printing, the setting for “flash” is set to be disabled, and the setting for “sound” is set to be enabled. In the cloud printing, the setting for “flash” is set to be enabled and the setting for “sound” is set to be disabled.

According to the identification action and the state of the printing apparatus 101 set in this manner, the transmission of the printer attributes to the cloud print service 102 by the printing apparatus 101 compatible with cloud printing to be described later and the printer information response by the printing apparatus 101 compatible with local printing are changed.

In addition, as an initial state of the printing apparatus 101, for example, in a case where an action of sound is not performed when functioning as a cloud printer, an option of the corresponding sound setting 1604 may not be displayed or may be grayed out so as not to be selectable.

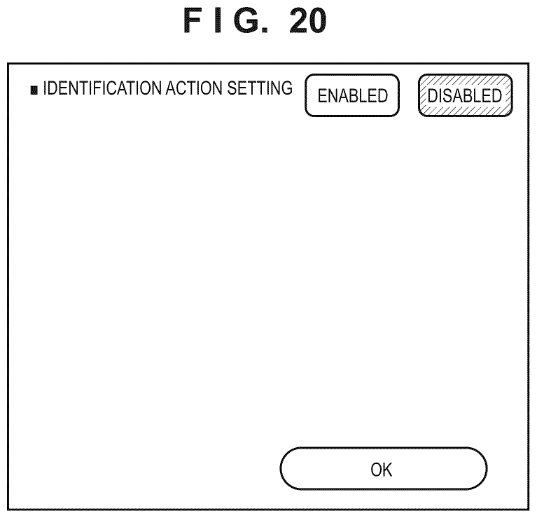

In addition, in a case where it is not desired to change the identification action between the case of the cloud printer and the case of the local printer, for example, enabled/disabled may be provided for the identification action setting as illustrated in FIG. 20.

FIG. 20 depicts a view illustrating another example of the identification action setting menu screen of the printing apparatus 101 according to the second embodiment.

On this screen, it is possible to set whether to make the change in the identification action enabled or disabled between the case of the cloud printer and the case of the local printer as the identification action setting, where the change in the identification action is set to be disabled in FIG. 20. When set to be disabled, the printing apparatus 101 notifies the common attribute of Identify-actions-supported in both cases of functioning in a cloud printer and functioning as a local printer.

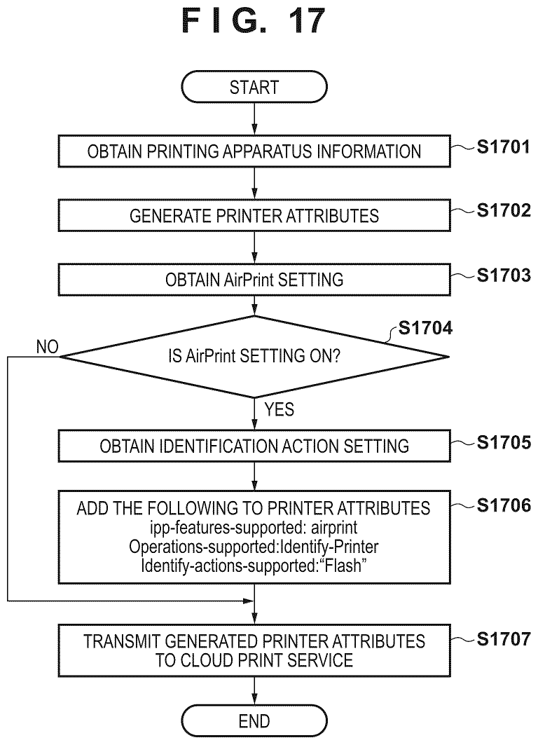

FIG. 17 is a flowchart for explaining processing when the printing apparatus 101 according to the second embodiment transmits the printer attributes 135 to the cloud print service 102. This is processing when the printing apparatus 101 transmits the printer information update request 140 to the cloud print service 102 in the processing sequence of cloud printing in FIG. 1. Note that the processing described in the flowchart of FIG. 17 is realized by the CPU 402 of the printing apparatus 101 executing a program deployed in the RAM 403 and functioning as the functional module illustrated in FIG. 5. In addition, in FIG. 17, since the processing in steps S1701 to S1703 are the same as those in steps S1301 to S1303 in FIG. 13, the description thereof will be omitted.

In a case that it is determined in step S1704 that the AirPrint setting 1102 is turned on, that is, AirPrint is enabled, the processing proceeds to step S1705, and in a case that it is determined that AirPrint is disabled, the processing proceeds to step S1707. In step S1705, the CPU 402 functions as the storing module 506, and obtains the identification action setting stored in the HDD 414. Here, since the printer information of the cloud print service 102 is to be updated, the set value of the cloud printer is obtained.

In the second embodiment, as illustrated in FIG. 16, since the flash setting 1603 is set to be enabled when functioning as a cloud printer, “flash” is added in the next sequence. Then, the processing proceeds to step S1706, where the CPU 402 functions as the cloud print device information management module 505, and sets the attribute value “airprint” of the attribute of ipp-features-supported in the printer attributes 135. Furthermore, the attribute value “Identify-Printer” is set to the attribute operations-supported. Furthermore, the attribute value “flash” is added to the attribute Identify-actions-supported, and the processing proceeds to step S1707. In step S1707, the CPU 402 functions as the cloud print device information management module 505, and transmits the generated printer attributes 135 to the cloud print service 102.

According to this processing, the printing apparatus 101 can notify the cloud print service 102 of the printer attributes corresponding to the setting for each identification action set on the screen of FIG. 16.

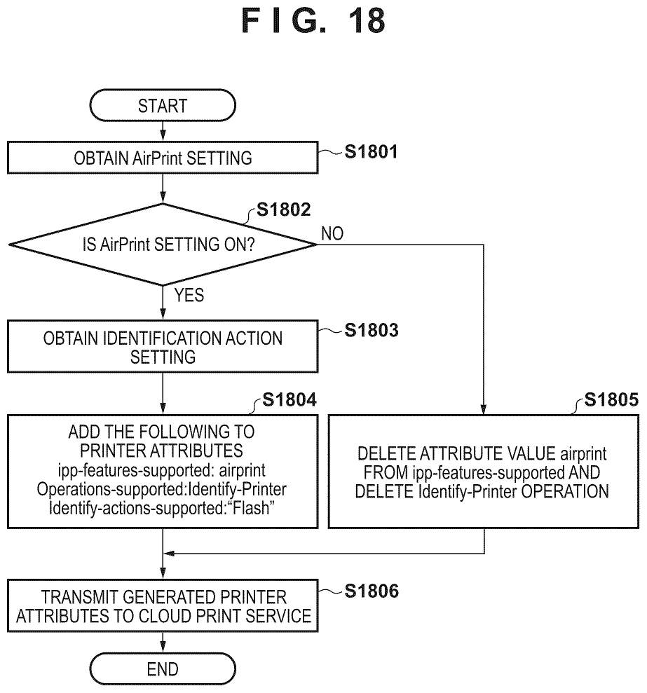

FIG. 18 is a flowchart for explaining processing when the printing apparatus 101 transmits the printer attributes to the cloud print service 102 when the AirPrint setting of the printing apparatus 101 according to the second embodiment is changed. Note that the processing described in the flowchart of FIG. 18 is realized by the CPU 402 of the printing apparatus 101 executing a program deployed in the RAM 403 and functioning as a functional module illustrated in FIG. 5. Note that the processing in step S1801 is the same as that in step S1401 in FIG. 14 described above, and thus the description thereof will be omitted.

In step S1802, the CPU 402 determines whether AirPrint is enabled in the AirPrint setting 1102, and the processing proceeds to step S1803 in a case that it is determined that AirPrint is enabled, and the processing proceeds to step S1805 in a case that it is determined that AirPrint is disabled, that is, the AirPrint setting has been changed from enabled to disabled. In step S1803, the CPU 402 functions as the storing module 506, and obtains the identification action setting stored in the HDD 414. Here, since the printer information of the cloud print service 102 is to be updated, the set value of the cloud printer is obtained.

In the second embodiment, as illustrated in FIG. 16, since the flash setting is enabled when functioning as a cloud printer, an attribute value “flash” is added in the next sequence. Then, in step S1804, the CPU 402 functions as the cloud print device information management module 505, and sets the attribute value “airprint” of the attribute ipp-features-supported in the printer attributes 135. Furthermore, the attribute value “Identify-Printer” is set to the attribute operations-supported. Furthermore, the attribute value “flash” is added to the attribute Identify-actions-supported, and the processing proceeds to step S1806.

When the AirPrint setting is changed from enabled to disabled, the CPU 402 functions as the cloud print device information management module 505 in step S1805, and deletes the attribute value “airprint” from the attribute ipp-features-supported of the printer attributes 135. Furthermore, the “Identify-Printer” operation is deleted, and the processing proceeds to step S1806. In step S1806, the CPU 402 functions as the cloud print device information management module 505, and transmits the generated printer attributes 135 to the cloud print service 102.

According to this processing, when the AirPrint setting of the printing apparatus 101 is changed, the printing apparatus 101 can notify the cloud print service 102 of the printer attributes corresponding to the setting for each identification action set on the screen of FIG. 16.

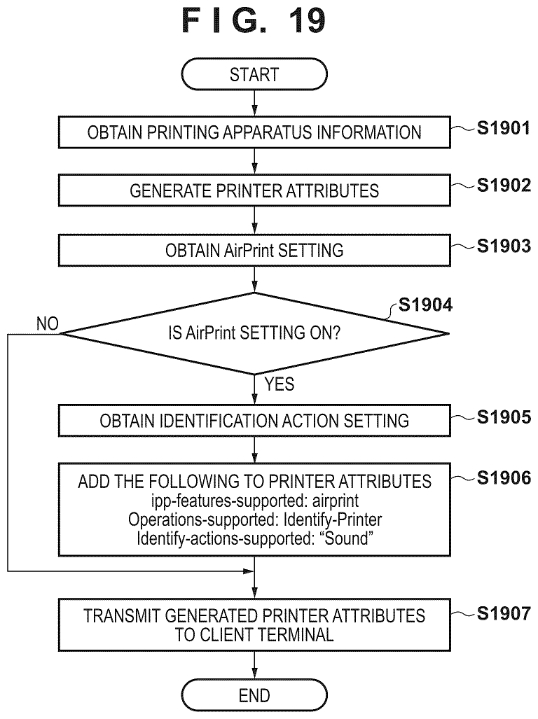

FIG. 19 is a flowchart for explaining processing when the printing apparatus 101 according to the second embodiment transmits the printer attributes to the client terminal 100. This is processing when the printing apparatus 101 transmits the printer information response 204 in the processing sequence diagram of local printing in FIG. 2. Note that the processing described in the flowchart of FIG. 19 is realized by the CPU 402 of the printing apparatus 101 executing a program deployed in the RAM 403 and functioning as the functional module illustrated in FIG. 5. Note that the processing in steps S1901 to S1903 are the same as the processing in steps S1501 to S1503 in FIG. 15 described above, and thus the description thereof will be omitted.

In step S1904, the CPU 402 determines whether AirPrint is set to be enabled in the AirPrint setting 1102, and the processing proceeds to step S1905 in a case that it is determined that AirPrint is set to be enabled, and the processing proceeds to step S1907 in a case that it is determined that AirPrint is set to be disabled. In step S1905, the CPU 402 functions as the storing module 506, and obtains the identification action setting stored in the HDD 414. Here, since it is a response of the printer information in the local printing, the set values of the local printer are obtained.

In the second embodiment, as illustrated in FIG. 16, since the sound setting is set to be enabled when functioning as a local printer, the attribute value “sound” is added in the next sequence. Then, the processing proceeds to step S1906, where the CPU 402 functions as the local print device information management module 512, and sets the attribute value “airprint” of the attribute ipp-features-supported in the printer attributes 212. Furthermore, the attribute value “Identify-Printer” is set to the attribute operations-supported. Furthermore, an attribute value “sound” is added to the attribute Identify-actions-supported. Then, the processing proceeds to step S1907, where the CPU 402 functions as the local print device information management module 512 and transmits the generated printer attributes 212 to the client terminal 100.

According to this processing, when AirPrint is set in the printing apparatus information, the printing apparatus 101 can notify the client terminal 100 of the printer attributes 212 corresponding to the setting for each identification action set on the screen of FIG. 16.

As described above, according to the second example, a printing apparatus supporting AirPrint is able to notify a user of a set identification action in response to a request for Identify-Printer operation from an AirPrint-compatible client terminal in both local printing and cloud printing.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-022203, filed Feb. 16, 2024, which is hereby incorporated by reference herein in their entirety.

What is claimed is:

1. A printing apparatus comprising:
one or more controllers including one or more processors and one or more memories, the one or more controllers configured to:
be operable to cause the printing apparatus to function as a local printer that receives a print job from a client terminal and performs printing;
be operable to cause the printing apparatus to function as a cloud printer that receives a print job from a cloud server and performs printing;
set whether a predetermined print function is enabled or disabled in a case that the printing apparatus functions as the local printer;
add an attribute for performing a presence notification of the printing apparatus to attribute information of the printing apparatus in a case that the predetermined print function is set to enabled; and
notify the attribute information of the printing apparatus to the cloud server.

2. The printing apparatus according to claim 1, wherein the one or more controllers is further configured to set the attribute for performing the presence notification of the printing apparatus in each case of that the printing apparatus functions as the local printer and that the printing apparatus functions as the cloud printer.

3. The printing apparatus according to claim 2, wherein, in the adding of the attribute for performing the presence notification of the printing apparatus to the attribute information of the printing apparatus, the one or more controllers is further configured to: add the set attribute to the attribute information of the printing apparatus depending on whether the printing apparatus functions as the local printer or functions as the cloud printer.

4. The printing apparatus according to claim 1, wherein the attribute for performing the presence notification of the printing apparatus includes a ringing sound or a lighted display.

5. The printing apparatus according to claim 1, wherein, in the notifying the attribute information of the printing apparatus to the cloud server, the one or more controllers is configured to: notify the client terminal in a case that the printing apparatus functions as the local printer, and notify the cloud server in a case that the printing apparatus functions as the cloud printer.

6. The printing apparatus according to claim 1, wherein, in the notifying the attribute information of the printing apparatus to the cloud server, the one or more controllers notifies the cloud server of the attribute information at a timing at which the printing apparatus has been registered as the cloud printer.

7. The printing apparatus according to claim 1, wherein, in the notifying the attribute information of the printing apparatus to the cloud server, the one or more controllers notifies the cloud server of the attribute information at a timing at which the printing apparatus is activated in a state in which the printing apparatus is registered as the cloud printer.

8. The printing apparatus according to claim 1, wherein, in the notifying the attribute information of the printing apparatus to the cloud server, the one or more controllers notifies the cloud server of the attribute information is at a timing at which a function as the cloud printer is set to be enabled.

9. The printing apparatus according to claim 1, wherein, in the notifying the attribute information of the printing apparatus to the cloud server, the one or more controllers notifies the cloud server of the attribute information is at a timing at which a setting of the predetermined print function is changed.

10. The printing apparatus according to claim 1, wherein, in the notifying the attribute information of the printing apparatus to the cloud server, the one or more controllers notifies the cloud server of the attribute information is at a timing at which configuration information of the printing apparatus changes.

11. The printing apparatus according to claim 1, wherein, in the notifying the attribute information of the printing apparatus to the cloud server, the one or more controllers notifies the cloud server of the attribute information is at a timing at which state information of the printing apparatus changes.

12. The printing apparatus according to claim 1, wherein, in the notifying the attribute information of the printing apparatus to the cloud server, the one or more controllers is further configured to notify the attribute information to the client terminal in response to a request from the client terminal.

13. The printing apparatus according to claim 1, wherein the predetermined print function is a print function by AirPrint.

14. A method of controlling a printing apparatus, the method comprising:
being operable to cause the printing apparatus to function as a local printer that receives a print job from a client terminal and performs printing;
being operable to cause the printing apparatus to function as a cloud printer that receives a print job from a cloud server and performs printing;
setting whether a predetermined print function is enabled or disabled in a case that the printing apparatus functions as the local printer;
adding an attribute for performing a presence notification of the printing apparatus to attribute information of the printing apparatus in a case that the predetermined print function is set to enabled; and
notifying the attribute information of the printing apparatus to the cloud server.

15. A non-transitory computer-readable storage medium for storing a program for causing a processor to execute a method of controlling a printing apparatus, the method comprising:
being operable to function as a local printer that receives a print job from a client terminal and performs printing;
being operable to function as a cloud printer that receives a print job from a cloud server and performs printing;
setting whether a predetermined print function is enabled or disabled in a case that the printing apparatus functions as the local printer;
adding an attribute for performing a presence notification of the printing apparatus to attribute information of the printing apparatus in a case that the predetermined print function is set to enabled; and
notifying the attribute information of the printing apparatus to the cloud server.
